(19) United States
(12) Patent Application Publication
(10) Pub. No.: US 2025/0219576 A1
(43) Pub. Date: Jul. 3, 2025

(54) FAILURE DIAGNOSIS METHOD AND PROGRAM FOR SOLAR CELL MODULE

(71) Applicant: Laplace System Co., Ltd., Kyoto-shi, Kyoto (JP)

(72) Inventors: Masayuki HORII, Kyoto-shi, Kyoto (JP); Kunihiko IKUTA, Kyoto-shi, Kyoto (JP)

(21) Appl. No.: 18/687,694

(22) PCT Filed: Aug. 30, 2022
(86) PCT No.: PCT/JP2022/032658

§ 371 Date: Mar. 13, 2025

(30) Foreign Application Priority Data
Aug. 31, 2021 (JP) 2021-141871

(51) Int. Cl. H02S 50/00; H02J 3/38

(52) U.S. Cl. CPC H02S 50/00; H02J 3/38; H02J 2300/26

(57) ABSTRACT

An I-V curve of a string is obtained from various measurement values constantly acquired from a power generation control device (PCS) during operation of a photovoltaic system, and a failure that can be found only at an I-V curve level can be diagnosed. In a photovoltaic system including a power generation control device with an output control function, and a control terminal that gives the power generation control device an output command value and receives measurement data of the power generation control device, the control terminal continuously and stepwise changes the control command value between 100% and 0% and sends the control command value to the power generation control device, and, by sequentially acquiring and recording a voltage value and a current value obtained as a response output, draws a part of an I-V curve. Furthermore, a method for obtaining a complete I-V curve from a partial I-V curve is also provided.

### CROSS REFERENCE TO RELATED APPLICATIONS

The present application is a U.S. National Phase of International Application No. PCT/JP2022/032658 entitled “FAILURE DIAGNOSIS METHOD FOR SOLAR CELL MODULE, AND PROGRAM,” and filed on Aug. 30, 2022. International Application No. PCT/JP2022/032658 claims priority to Japanese Patent Application No. 2021-141871 filed on Aug. 31, 2021. The entire contents of each of the above-listed applications are hereby incorporated by reference for all purposes.

### TECHNICAL FIELD

The present invention relates to a failure diagnosis method for a solar cell module, more specifically, a failure diagnosis method using measurement of an I-V characteristic using an output control function of a photovoltaic power control device.

### BACKGROUND ART

As a failure diagnosis technology in photovoltaic systems, various techniques are known depending on failure portions, causes, and the like. Among them, the most accurate and detailed method for diagnosing the state of strings (input circuit) connected to respective solar cell modules is to measure a current-voltage characteristic (hereinafter, called “I-V curve”) of each string.

As a device for measuring an I-V curve of a string, an external measuring instrument called a “solar cell module characteristics test apparatus” is known (Patent Literature 1). Measuring the I-V curve makes it possible to correctly determine whether or not the solar cell is operating with a predetermined characteristic value.

However, the solar cell module characteristics test apparatus is merely an inspection device and is not a “monitoring system” that can be used during normal operation, and therefore, when using this device, it is necessary to disconnect the solar cell module by disconnecting the string in order to stop a power generation control device (power conditioning system) and connect the system in advance. Alternatively, it becomes necessary to perform measurement in the early morning or the evening when the solar radiation intensity is weak (e.g., paragraphs 8 to 21 of Patent Literature 2). However, in general, when the I-V curve is measured, it is preferable that the solar radiation intensity be a certain degree of intensity.

There is an upper limit (e.g., about 10 KW, or less depending on the model) of the capacity that can be measured by the solar cell module characteristics test apparatus to be connected, and there is also a problem that an expensive external device needs to be prepared. Furthermore, in addition to these technical problems, the fact that a technician with specialized knowledge has to work on site also causes an increase in the maintenance cost of the entire system.

### CITATIONS LIST

Patent Literature 1: JP 2017-108586 A
Patent Literature 2: JP 2017-63591 A

### SUMMARY OF INVENTION

### Technical Problems

It is considered to be technically extremely difficult to obtain the I-V curve of a string from various measurement values constantly acquired from the power generation control device (PCS) during operation of the photovoltaic system. A current general power generation control device performs maximum power point tracking (MPPT) control in which a solar cell module constantly operates with maximum power, and acquires data such as a voltage value and a current value (maximum output operating voltage Vpmax, maximum output operating current Ipmax) at the maximum power point for each sampling period (e.g., 1 minute). The data amount is 525600 items (60×24×365) per year per data in a case of a system that acquires data every minute.

On the other hand, since there are five parameters (n, Iₚₕ, I₀, Rₛ, Rₚ) of the I-V curve and there are four data that can be acquired for five unknowns, it is considered to be impossible to derive a solution analytically. Applying numerical calculation, big data analysis, artificial intelligence (AI) analysis, or machine learning for obtaining an I-V curve is considered to be unrealistic at least at present.

An object of the present invention is to solve the above technical problem, and to enable diagnosis of a failure that can be found only at an I-V curve level using a control terminal (measurement control system) including a function of giving a power generation control device an upper limit of a power generation amount to as a control command value.

### Solutions to Problems

An acquisition method of an I-V curve according to the present invention is an acquisition method, in which in a photovoltaic system including a power generation control device with an output control function, and a control terminal that gives the power generation control device an output command value and receives measurement data of the power generation control device, the control terminal continuously and stepwise changes the control command value between 100% and 0% and sends the control command value to the power generation control device, and, by acquiring and recording a voltage value and a current value obtained as a response to the output, draws (graphs) a part of an I-V curve.

This drawing (graphing) work is implemented by preparing and executing a time-varying program that changes the control command value on the control terminal in advance. The execution of the program is completed in 10 minutes or less regardless of the capacity of the photovoltaic system. If the control terminal is remote controllable, a power generation control device at a remote location can be controlled, and thus, it is possible to perform the drawing work without the need for disconnecting the string during normal operation. Specialized knowledge and a dedicated test apparatus become unnecessary, there is no longer the need for sending a technician to the site, and safety is high.

The present invention can be applied to a failure diagnosis method for diagnosing a failure by comparing a part of an I-V curve drawn using the acquisition method of an I-V curve with a part or the entirety of an I-V curve drawn for a normal solar cell module or a part or the entirety of an I-V curve measured and drawn for another string.

An acquisition program of a partial I-V curve according to the present invention includes a step of measuring, in a photovoltaic system including a power generation control device with an output control function connected to a power generation module and a control terminal that sends an output command value to the power generation control device, an I-V curve from a maximum power point to an open voltage side (i.e., an intersection with a horizontal axis V in the I-V curve) while decreasing a maximum power of the power generation control device by the control terminal measuring values of a voltage and a current of the power generation module at each time when continuously and stepwise changing the output command value from 100% to 0% with respect to the power generation control device. The failure can be diagnosed based on the shape of the I-V curve drawn in this manner.

### Advantageous Effects of Invention

According to the present invention, it is possible to diagnose a failure that can be found only at the I-V curve level while operating and constantly monitoring a photovoltaic system even though there is no need for an external measuring instrument, no need for disconnecting the string, and no need for work on site.

### BRIEF DESCRIPTION OF DRAWINGS

FIGS. 1(A) and (B) are block diagrams illustrating the configuration of a typical power generation control system.

FIG. 2(A) is an ideal I-V curve illustrating a relationship between an output current and an output voltage of a power generation control device. FIG. 2(B) is a power-voltage characteristic (hereinafter, called “P-V curve”) drawn based on the I-V curve.

FIGS. 3(A) to 3(C) are graphs showing an example of an “I-V curve” measured using a solar cell module characteristics test apparatus.

FIGS. 4(D) to 4(F) are graphs showing an example of an “I-V curve” measured using a solar cell module characteristics test apparatus.

FIGS. 5(A) and 5(B) illustrate actual measurement data in which an I-V curve of a power generation control device installed at point X, which is a remote place, is measured during operation by the above-described method.

FIG. 6 illustrates an equivalent circuit of a solar cell.

FIG. 7(A) is a graph showing a relationship between an output current and an output voltage of a power generation control device measured in an intentional failure state. FIG. 7(A) expresses fitting as a combination of two quadratic functions. That is, it can be seen that the number of approximate function equations is 2. FIG. 7(B) expresses fitting as one quadratic function. Therefore, an abnormal solar cell module is estimated not to exist.

FIGS. 8(G) to 8(I) are graphs showing an example of an “I-V curve” measured using a solar cell module characteristics test apparatus.

FIGS. 9(J) to 9(L) are graphs showing an example of an “I-V curve” measured using a solar cell module characteristics test apparatus.

### DESCRIPTION OF EMBODIMENTS

Embodiments of the present invention will be described below with reference to the drawings. However, any of the following embodiments does not give any restrictive interpretation in finding the gist of the present invention. Members that are identical or of a same type are denoted by the same reference signs, and the description may be omitted.

### (First Embodiment)—Regarding Problem Solving Principle/Acquisition Method for Partial I-V Curve

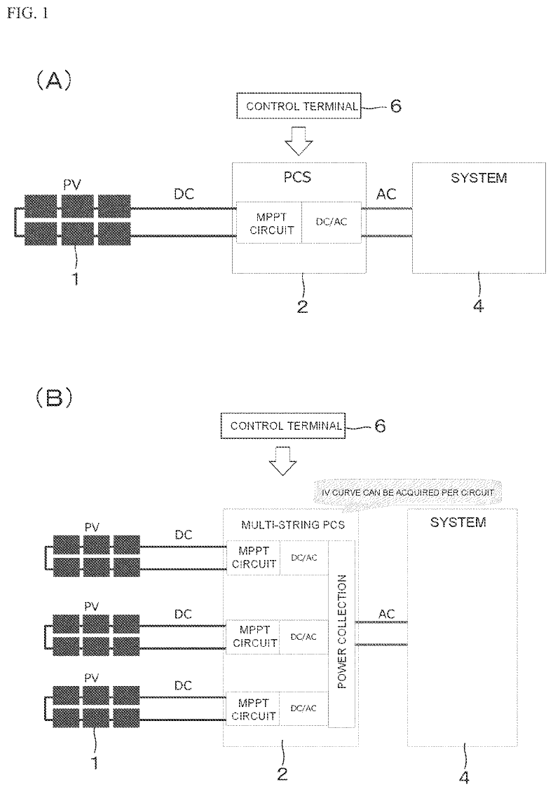

FIGS. 1(A) and (B) are block diagrams illustrating the configuration of a typical power generation control system. A solar cell module 1 is connected to a power generation control device 2, and supplies a load (not illustrated) with power in connection with a system 4. A control terminal 6 is connected to the power generation control device 2 via a signal line, plays a role of a measurement terminal that receives and records measurement data from the power generation control device, and sends a control command value as necessary.

The power generation control device 2 has main constituent elements of a circuit (MPPT circuit) that performs maximum power point tracking control (MPPT control) and an inverter circuit that converts direct current power generated by the solar cell module into alternating current power. Note that a single string power generation control device as illustrated in FIG. 1(A) includes a configuration in which a junction box is installed between the solar cell module 1 and the power generation control device (PCS), where a plurality of strings are aggregated, bundled into one system, and input to the power generation control device. In the case of a multi-string (multi-input circuit) power generation control device as illustrated in FIG. 1(B), each solar cell module is provided with a plurality of MPPT circuits and a plurality of inverters independently, and the MPPT circuit operates for each string.

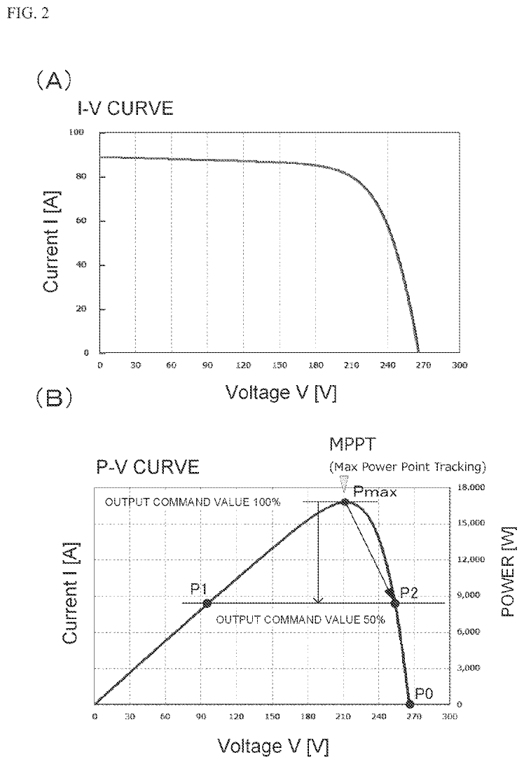

FIG. 2(A) is an ideal I-V curve illustrating the relationship between an output current and an output voltage of the power generation control device. The I-V curve is a graph of transition of the direct voltage and the direct current when a variable resistor is connected to the solar cell module and the resistance value is changed from 0Ω to ∞ (infinity) Ω. However, drawing such I-V curve requires disconnecting the power generation control device by disconnecting the strings, and such I-V curve cannot be drawn when the photovoltaic system is in operation.

FIG. 2(B) is a power-voltage characteristic (hereinafter, called “P-V curve”) drawn based on the I-V curve. Since power P is a product of current and voltage, a P-V curve (power-voltage curve) can be drawn by calculation with the vertical axis of the I-V curve as P. When focusing on the generated power, the maximum value Pmax of P becomes important in the P-V curve.

Here, the MPPT control, which is a function of the power generation control device (power conditioning system) side, will be briefly described. In general, the power generation control device calculates the power-voltage (hereinafter, called “P-V curve”) based on the I-V curve, and converts and outputs power at the maximum power point thereof into alternating current. However, the actual power generation control device does not draw the I-V curve or the P-V curve, but repeats the operation of obtaining the “maximum power point” by so-called “trial and error” by using an algorithm of searching the maximum value Pmax of the current power P. Therefore, the maximum power point obtained by the search does not necessarily coincide with the maximum power point (true Pmax) on the P-V curve.

On the other hand, in a case of a power generation control device having an “output control function” that sets an upper limit value on the power generation output and restricts the power generation output, output is performed with commanded power by varying a resistance value and shifting from the maximum power point during output control.

For example, when a facility having a rated capacity of 100 kW is given 50% of rated output as an output command value, a current I and a voltage V are determined such that 100 kW×50%=50 kW becomes a generable maximum power. For example, in the example of FIG. 2(B), there are two points (P1, P2) of the voltage V that becomes 50% of the maximum power point Pmax. In this case, it is common for the power generation control device to perform control of shifting the output voltage from the maximum power point to an “open voltage side” (high voltage side) by setting the resistance value to the point P2 on a higher resistance side than the resistance value from which Pmax is obtained.

That is, in the photovoltaic system in normal operation, the MPPT control circuit operates, and when not given the output command value (i.e., when the output command value is 100%), the operation is performed while repeatedly searching the maximum power point Pmax. Therefore, it is not possible to find the I-V curve of the string during the operation, but it is possible to find at least the maximum power point Pmax obtained by the search and the current value Imax and the voltage value Vmax at that point, whereby the control terminal can acquire the direct current Imax and the direct voltage Vmax at the maximum power point Pmax acquired by the power generation control device.

On the other hand, when the control terminal gives the power generation control device an output command value, the power generation control device can set the upper limit value of a generable output power from the maximum power point Pmax to a predetermined power point Px and obtain a current value Iₓ and a voltage value Vₓ at the point Px. This enables the control terminal to acquire the current value Iₓ and the voltage value Vₓ at the power point Px set by the power generation control device.

When applying this mechanism and continuously decreasing the power generation output of the power generation control device stepwise (e.g., for each 1 cycle) from 100% to 0%, for example, in decrements of 1%, it becomes possible to draw a “partial I-V curve” from the point Pmax to a point P0 illustrated in FIG. 2(B). In this case, for example, control and measurement to the power generation control device are performed from 100% to 0% at intervals of 1% for 10 seconds (100 msec communication measurement×100 times=10 seconds). Such technique is suitable for a power generation control device having a short slope time. Note that there is also a system in which the slope is controlled and changed on the power generation control device side only by giving final output in % from 100% to 0% vice versa.

FIG. 1(B) illustrates the configuration of a multi-string power generation control device. Thus, in a case of a power generation control device having the configuration including an MPPT circuit and a DC/AC inverter for each string (input circuit), the “partial I-V curve” can be drawn string by string. By acquiring and comparing the I-V curve for each string, it becomes easy to find an abnormality in the string.

Alternatively, in a case of not the multi-string type, a control instruction is given from no control (100%) to output 0% to the power generation control device that collectively gives instructions on the control rate and performs measurement, the values of the current and voltage being changed are measured, and one I-V curve is acquired.

### (Second Embodiment)—Estimation Method of Complete I-V Curve

It is a method of estimating a complete I-V curve by, based on the partial I-V curve from the right side of the maximum power point, that is, the maximum power point Pmax to the open voltage side obtained by the above technique, defining and expressing, with an approximate equation, a model equation of the I-V curve on the left side of the maximum power point, that is, a short circuit current side. A specific method is as follows.

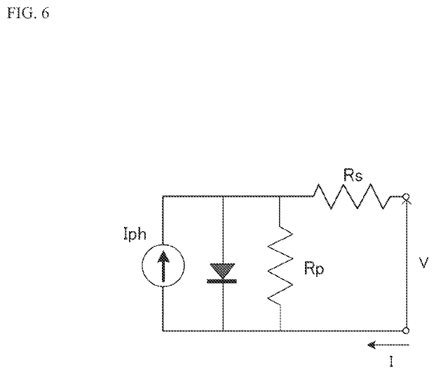

FIG. 6 illustrates an equivalent circuit of a solar cell. Here, the symbols indicated in the circuit diagram have the meanings as follows.

Current: I, voltage V, Iₚₕ: generated photovoltaic current, Rₛ: series resistance, Rₚ: parallel resistance

In this equivalent circuit, the relationship between the current I flowing through the solar cell and an electromotive force V generated by the solar cell is expressed as the following Equation 1 using the series resistance Rₛ and the parallel resistance Rₚ.

$$I = {I}_{p h} - {I}_{0} [ exp \{ \frac{q ( V + {R}_{s} I )}{n k T} \} - 1 ] - \frac{V + {R}_{s} I}{{R}_{p}} \qquad [ Equation 1 ]$$

Here, the constants included in the symbols in Equation 1 have the meanings as follows.

I₀: diode saturation current, n: diode factor, k: Boltzmann constant, q: elementary charge, T: absolute temperature of solar cell

From four equations (Equations 2 to 5) related to short circuit current, open voltage, maximum power, and Ohm's law, assuming a standard test environment, that is, solar radiation of 1.0 kW/m² and a module temperature of 25° C., parameters (diode factor n, generated photovoltaic current Iₚₕ, diode saturation current I₀, series resistance Rₛ, and parallel resistance Rₚ) are obtained.

$$0 = {I}_{p h} - {I}_{0} [ exp \{ C \cdot {V}_{o c} \} - 1 ] - \frac{{V}_{o c}}{{R}_{p}} ( where C = q / nkT ) \qquad [ Equation 2 ]$$

$${I}_{s c} = {I}_{p h} - {I}_{0} [ exp \{ C \cdot {I}_{SC} {R}_{s} \} - 1 ] - \frac{{I}_{s c} \cdot {R}_{s}}{{R}_{p}} ( where C = q / nkT ) \qquad [ Equation 3 ]$$

$${I}_{Pmax} = {I}_{p h} - {I}_{0} [ exp \{ C ( {V}_{Pmax} + {I}_{Pmax} \cdot {R}_{s} ) \} - 1 ] - \frac{( {V}_{Pmax} + {I}_{Pmax} \cdot {R}_{s} )}{{R}_{p}} \qquad [ Equation 4 ]$$

$$V = I \cdot R \qquad [ Equation 5 ]$$

Here, the symbols V_{oc}, I_{sc}, I_{Pmax}, and V_{Pmax} in the above equations have the meanings as follows:

V_{oc}: open voltage, I_{sc}: short circuit current I_{Pmax}: current value at maximum power point Pmax;

V_{Pmax}: voltage value at maximum power point Pmax.

While the number of parameters to be obtained is 5 (n, Iₚₕ, I₀, Rₛ, Rₚ), the number of equations is 4, which is insufficient by 1, thereby failing to specify a unique solution. However, a technique of estimating parameters that becomes an optimal solution satisfying the four equations by arbitrarily changing the entire five parameters can be considered. Alternatively, a complete I-V curve can be obtained by finding an optimal solution of parameters fitting to the partial I-V curve described in the first embodiment.

Since such parameter estimation results in a so-called optimal solution search problem, which is what machine learning using artificial intelligence (AI) is good at. Currently available artificial intelligence (AI) includes various methods such as a deep neural network (DNN), a convolutional neural network (CNN), and a recurrent neural network (RNN), but all methods can be used for the optimal solution search.

Then, the I-V curve as in FIG. 2(A) or the P-V curve as in FIG. 2(B) can be reproduced in a complete form by obtaining five parameters by estimation of parameters using machine learning and substituting them into Equation 1.

That is, in the first embodiment, since only a partial I-V curve from the maximum power point Pmax to the open voltage point can be obtained, it is not possible to detect an abnormality appearing in the I-V curve from the short circuit current to the maximum power point. However, in the second embodiment, it becomes possible to estimate a complete I-V curve including a right side part of the maximum power point acquired in advance as an actual measurement value and a part (left side part of the maximum power point) from the maximum power point to the short circuit current side.

Estimating the entire I-V curve in this manner makes it possible to detect an abnormality that cannot be detected by a partial I-V curve. This point will be described in the fifth embodiment.

### (Third Embodiment)—Acquisition Method of I-V Curve Not Relying on Fitting

Note that as an acquisition method of a complete I-V curve not relying on fitting, a method of providing the power generation control device with a function of shifting in the P1 direction where the resistance value is on a 0 [Ω] side (short circuit current side) is considered. This method makes it possible to draw a graph on the left side of Pmax, that is, on the short circuit current side, and therefore a complete I-V curve can be acquired by performing the method by the first embodiment and the method by the present embodiment. However, implementing this requires design change and the like on the power generation control device side.

### (Fourth Embodiment)—Regarding Failure Diagnosis by Partial I-V Curve

### (i) Diagnosis Based on Shape of Graph

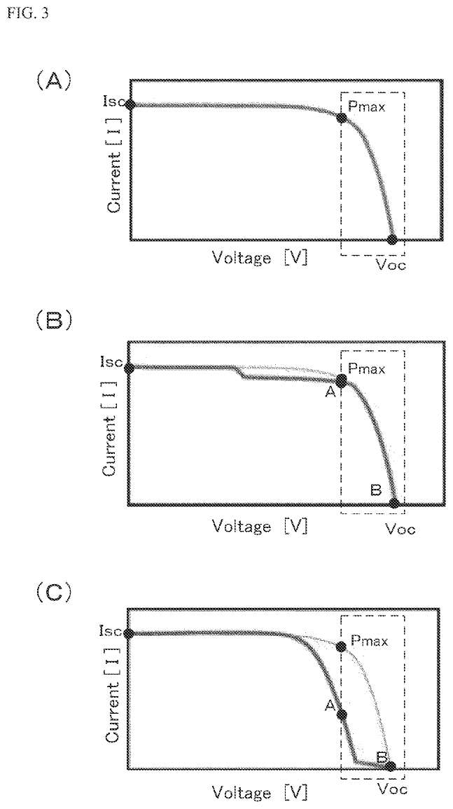

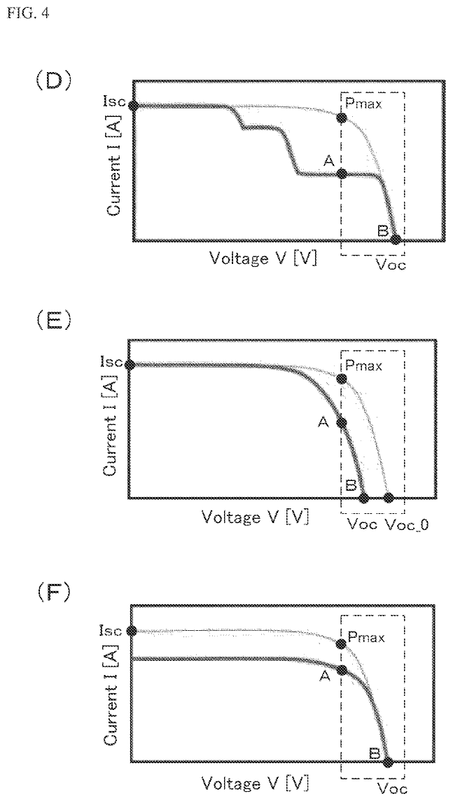

FIGS. 3 to 4 each show an example of an “I-V curve” measured using a solar cell module characteristics test apparatus. As described above, when an I-V curve is measured using the solar cell module characteristics test apparatus, it is necessary to disconnect the solar cell module by disconnecting the strings, but a complete I-V curve can be acquired. On the other hand, the partial I-V curve acquires only the region indicated by the broken line during the operation of the photovoltaic system.

FIG. 3(A) is an I-V curve in a state where the solar cell module is functioning normally. The reason for “partial” lies in that the horizontal axis V [V] of the graph representing the direct voltage is the voltage Vmax at the maximum power point Pmax or a voltage higher than that, and a voltage smaller than Vmax is not drawn. However, even such partial I-V curve can well represent the state of the solar cell module.

In FIG. 3(A), the shape of the graph extends substantially horizontally and then descends substantially perpendicularly. Here, if the values of I_{sc} and V_{oc} are values close to the specifications of the module, it can be determined that the string connected to this solar cell module is normally generating power.

When such “ideal I-V curve” is observed with a partial I-V curve, only the I-V curve in a part surrounded by the broken line is acquired. In this case, the partial I-V curve completely matches a part of the ideal I-V curve.

FIG. 3(B) is a slightly stepped I-V curve. Possible factors include:
mismatch of current specifications between modules (or an individual difference between the modules);
Small partial shadow, dirt, and deterioration of solar cell module surface
Breakage of module (e.g., microcracks and the like).

When such “slightly stepped I-V curve” is observed with a partial I-V curve, a characteristic graph is drawn in which the curve is sharply bent immediately after starting from a point A of a current value lower than the maximum current Imax at Pmax. The open voltage is equal to the ideal I-V curve.

FIG. 3(C) is a deeply stepped I-V curve. Possible factors include:
Some modules having large (or a plurality of) shadows or dirt;
(Relatively large) breakage of module (e.g., cracks or the like).

Regarding such “deeply stepped I-V curve”, a region from the left (short circuit current side) relative to the point A to the open voltage point becomes the draw region.

FIG. 4(D) is an I-V curve having several steps. Possible factors include:
Some modules having small to medium shadows or dirt;
(Relatively large) breakage of module (e.g., cracks or the like)
Short failure of bypass diode.

Regarding such “I-V curve having several steps”, a region from the left (short circuit current side) relative to the point A to the open voltage point becomes the draw region.

FIG. 4(E) is an I-V curve with a low Voc. This means that Voc is lower than that in the specification, and possible factors include:
Structural problems;
Measurement problems;
Module having a large shadow;
Module having earth fault;
Short failure of bypass diode.

Regarding such “I-V curve with low Voc”, a region from the left (short circuit current side) relative to the point A to the open voltage point becomes the draw region.

FIG. 4(F) is an I-V curve with a low Isc. This means that Ioc is lower than that in the specification, and possible factors include:
Structural problems;
Measurement problems;
String having even shadow or dirt;
Degradation of module;
Open failure of bypass diode in shadowed cell or cluster.

Regarding such “I-V curve with low short circuit current Isc”, a region from the left (short circuit current side) relative to the point A to the open voltage point becomes the draw region.

The open voltage Voc is equal to the open voltage of the ideal I-V curve, but the short circuit current Isc is lower than the current value (Imax) at the ideal Pmax, and therefore an abnormality can be diagnosed.

As described above, regarding the possibility of various failure causes that can be found only in the I-V curve, there is a case where an abnormality can be found even if only a “partial I-V curve” can be obtained, and according to the technique of the present embodiment, the abnormality can be found during normal operation.

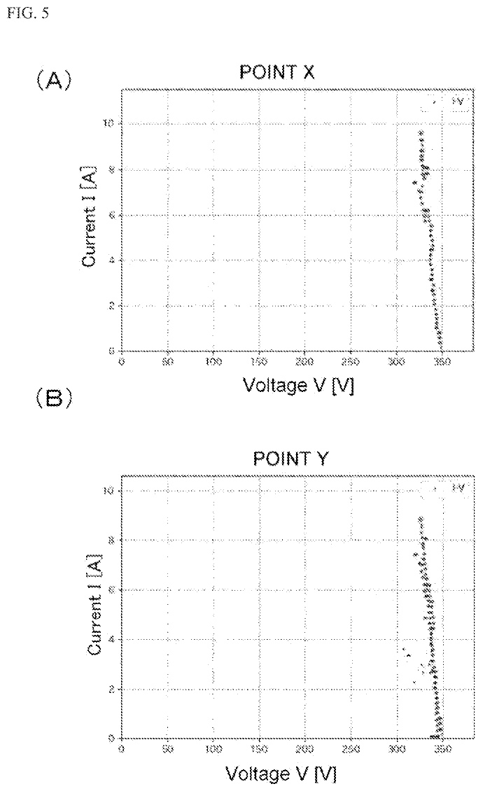

FIGS. 5(A) and 5(B) illustrate actual measurement data in which the I-V curve of the power generation control device installed at the point X, which is the remote place, is measured during the operation by the above-described method. The measurement time of each of these data was 10 minutes (command value transmission at 6 second intervals×100 points: 100% to 0%), and no failure was seen.

Note that since the solar radiation amount for 10 minutes was not constant, some fluctuation was observed. In future, it is ideal that acquisition can be performed within 1 second, and at longest 10 seconds, but currently, due to restrictions on the power generation control device side, it may take a longer time (about 1 minute to 10 minutes). Both were measured under the same conditions except the time of day, the solar radiation amount, and the temperature.

By intentionally making a shadowed state and carrying out I-V curve acquisition at the time of abnormality, it is also possible to use it for failure diagnosis.

### (ii) Diagnosis Based on Fitting Using Quadratic Function

According to the detailed study of the inventor of the present application, it has been found that a partial I-V curve created based on actual measurement data can be well approximated by a relatively simple quadratic function. For fitting a partial I-V curve by a general equation of I-V curve, long-term repeated learning based on sufficient training data is required. However, a technique of approximating by a quadratic function can be relatively easily implemented because it is expressed with only three parameters of a second-order coefficient, a first-order coefficient, and a zero-order coefficient.

Specifically, the presence or absence of an abnormality can be determined by estimating the number of approximate function equations expressing the obtained partial I-V curve. This estimation results in solving an optimization problem targeting for the number of approximate function equations, the coefficients of each relational expression, and the constant term.

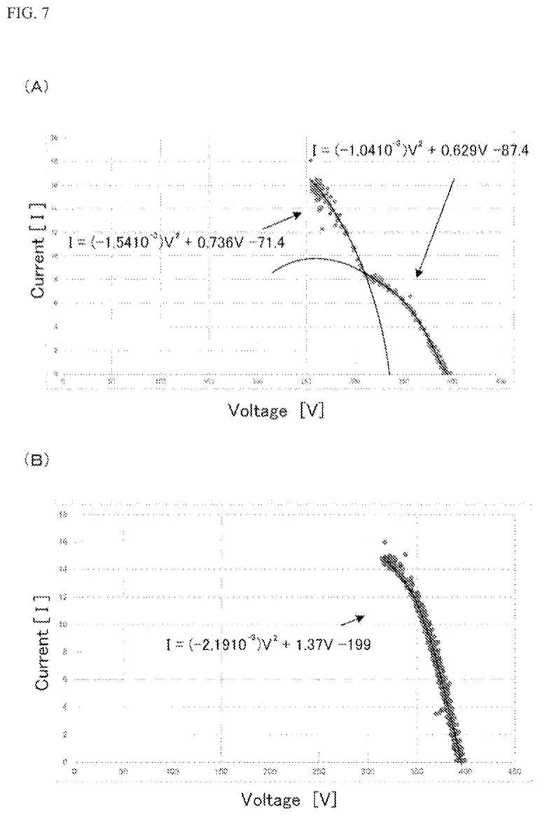

FIG. 7(A) is a graph showing the relationship between an output current and an output voltage of a power generation control device measured in an intentional failure state. The calculation equation written in the graph represents an equation in which a measurement value is fitted with a quadratic function. FIG. 7(A) expresses fitting as a combination of two quadratic functions. That is, it can be seen that the number of approximate function equations is 2. In contrast, FIG. 7(B) expresses fitting as one quadratic function. Therefore, an abnormal solar cell module is estimated not to exist.

### (Fifth Embodiment)—Regarding Failure Diagnosis by Complete I-V Curve

According to the technique described in the second embodiment or the third embodiment, a “complete I-V curve” including a partially acquired I-V curve can be acquired.

Thus, by estimating the entire I-V curve, it is expected that an abnormality that is difficult to detect by a partial I-V curve can be detected.

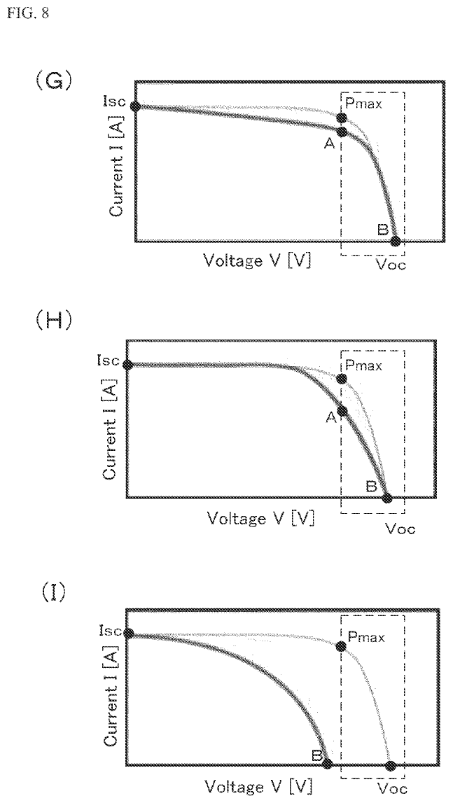

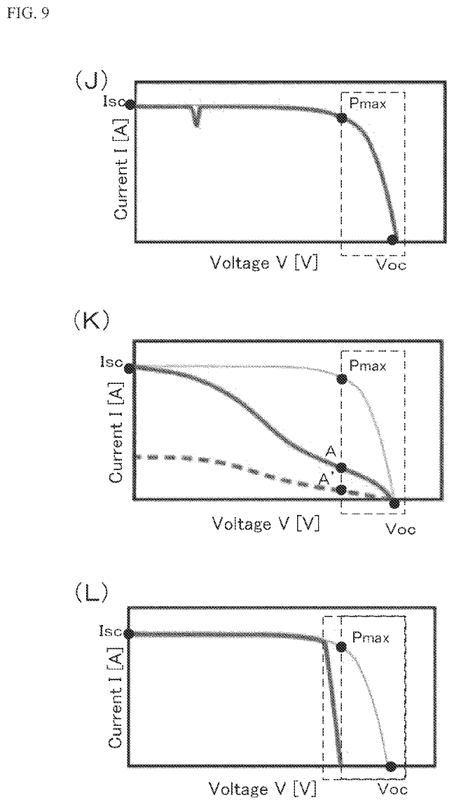

FIGS. 8(G) to 9(L) are each a graph showing an example of the “I-V curve” measured using the solar cell module characteristics test apparatus. Among them, if limiting to “findings observed in a range where a partial I-V curve is obtained” by the technique described in the first embodiment, a complete I-V curve reflecting the abnormality can be estimated. For example, in the case of FIGS. 8(G) and (H), since the current value at the point A appears as a current value lower than the current value (Imax) at Pmax, the abnormality can be detected by comparing the I-V curve appearing on the left side of Pmax with the normal (ideal) I-V curve.

In the case of FIG. 8(I), it is not possible to obtain a current-voltage point at which the power is equal to or as close as possible to the maximum power Pmax from the open voltage point, that is, since the voltage at V_{oc} point B is significantly smaller than the open voltage V_{oc}, a partial I-V curve cannot be obtained, and thus, it is possible to detect an abnormality.

In the case of FIG. 9(J), it is difficult to estimate a complete I-V curve, and thus it is considered to be difficult to find an abnormality. However, in the case of FIG. 9(K), since the current value at the voltage giving the maximum power point Pmax is smaller than the ideal current value, an abnormality can be detected.

In the case of FIG. 9(L), it can be seen that the output current rapidly becomes 0 by a change to the open voltage side from the state of actually outputting at a value close to the maximum power point Pmax as 100%. Therefore, the I-V curve for the part including the point at which the output is obtained can be acquired by changing a control command value from 0% to 100% on the contrary. At this time, since it becomes clear that the output voltage when the output starts to be obtained is significantly smaller than the open voltage Voc, it becomes possible to detect an abnormality

The time required for the operation of decreasing the power generation output of the power generation control device from 100% to 0% in a constant stepwise manner can be very short as compared with the operating time of the system. Therefore, even if such operation is performed, the influence on the photovoltaic system in operation is extremely small.

In changing the output command value of the power generation control device from 100% to 0%, also in order to avoid the influence of the solar radiation intensity and panel temperature change, it is preferable that the control rate transmission and the output control response be fast. When the solar radiation intensity and panel temperature measurement can be performed simultaneously, data accuracy will be improved.

By remotely operating the control terminal via a network such as the Internet and collecting data of the acquired I-V curve, it becomes possible to perform, in a short time, failure diagnosis based on the measurement data for the power generation modules in the photovoltaic systems installed all over the country.

### INDUSTRIAL APPLICABILITY

The present invention can be applied to all power generation control devices (power conditioning system) having a function of controlling generated power according to an output command value, and has extremely high industrial applicability.

### REFERENCE SIGNS LIST

1 solar cell module
2 power generation control device (power conditioning system)
4 system
6 control terminal

1. An acquisition method of an I-V curve, wherein
in a photovoltaic system including a power generation control device with an output control function, and a control terminal that gives the power generation control device an output command value and receives measurement data of the power generation control device,
the control terminal continuously and stepwise changes a control command value between 100% and 0% and sends the control command value to the power generation control device, and, by sequentially acquiring and recording a voltage value and a current value obtained as a response output, draws a part of an I-V curve.

2. A failure diagnosis method for diagnosing a failure by comparing a part of an I-V curve drawn using the acquisition method of an I-V curve according to claim 1 with a part or the entirety of an I-V curve drawn for a normal solar cell module or a part or the entirety of an I-V curve measured and drawn for another string.

3. An acquisition program of a partial I-V curve, comprising a step of measuring,
in a photovoltaic system including a power generation control device with an output control function connected to a power generation module and a control terminal that sends an output command value to the power generation control device,
an I-V curve from a maximum power point to an open voltage side while decreasing a maximum power of the power generation control device by the control terminal measuring values of a voltage and a current of the power generation module at each time when continuously and stepwise changing the output command value from 100% to 0% with respect to the power generation control device.

4. An acquisition method of an I-V curve, wherein the partial I-V curve is defined with a quadratic function by obtaining an approximate function equation using a parameter that approximates, with a quadratic function, a part of an I-V curve drawn using the acquisition method of an I-V curve according to claim 1.

5. A failure diagnosis method, wherein a presence or absence of a failure is diagnosed by determining whether or not a number of the approximate function equations according to claim 4 is one or two or more.

6. An acquisition method of an I-V curve, wherein a complete I-V curve is defined with a general equation by obtaining an approximate function equation using a parameters, in the general equation of an I-V curve, that approximates a part of an I-V curve drawn using the acquisition method of an I-V curve according to claim 1.

7. A failure diagnosis method for diagnosing a failure by comparing a complete I-V curve drawn using the acquisition method of an I-V curve according to claim 6 with a part or the entirety of an I-V curve drawn for a normal solar cell module or a part or the entirety of an I-V curve measured and drawn for another string.
